(19) United States
(12) Patent Application Publication
(10) Pub. No.: US 2023/0027427 A1
(43) Pub. Date: Jan. 26, 2023

(54) MEMORY-AUGMENTED GRAPH CONVOLUTIONAL NEURAL NETWORKS

(71) Applicants: Liheng MA, Montreal (CA); Yingxue ZHANG, Montreal (CA); Mark COATES, Montreal (CA)

(72) Inventors: Liheng MA, Montreal (CA); Yingxue ZHANG, Montreal (CA); Mark COATES, Montreal (CA)

(21) Appl. No.: 17/370,889

(22) Filed: Jul. 8, 2021

(51) Int. Cl. G06N 3/08; G06K 9/62

(52) U.S. Cl. CPC G06N 3/08; G06K 9/6288; G06K 9/6298; G06K 9/6296

(57) ABSTRACT

System and method for processing a graph that defines a set of nodes and a set of edges, the nodes each having an associated set of node attributes, the edges each representing a relationship that connects two respective nodes, comprising: generating a first node embedding for each node by: generating, for the node and each of a plurality of neighbour nodes, a respective first edge attribute defining a respective relationship type between the node and the neighbour node based on the node attributes of the node and the node attributes of the neighbour node; generating a first neighborhood vector that aggregates information from the generated first edge attributes and the node attributes of the neighbour nodes; generating the first node embedding based on the node attributes of the node and the generated first neighborhood vector.

### RELATED APPLICATIONS

None

### FIELD

This disclosure relates generally to the processing of graph based data using machine learning techniques, particularly using memory-augmented complex-relational graph convolutional neural networks.

### BACKGROUND

Data that has a complex or irregular structure can be represented using a graph. A graph is a data structure that includes nodes and edges. Each node in the graph represents one data point of the data. Each edge in the graph represents a relationship that connects two nodes in the graph. Different types of graphs are available for representing data. For example, unattributed graphs are graphs for which only relationships between nodes are defined and nodes have no attributes. Attributed graphs are graphs in which the nodes are a set of data points and each node is associated with a several attributes with the attributes (otherwise known as node features) associated with each respective node being represented as a multidimensional feature vector. In one type of attributed graph, the edges that connect respective nodes are all homogeneous, meaning that the presence or absence of an edge indicates the presence or absence of a predefined type of relationship between a pair of nodes. In such attributed graphs, the pre-defined relationships between pairs of nodes (i.e. node pairs) can be represented as a matrix of binary values that indicate the presence or absence of an edge between respective node pairs. In a further type of attributed graph, the relationship between a node pair can be different from the relationships between other node pairs. In the case of heterogeneous or complex node relationships, an edge, which represents a certain relationship between a node pair in the attributed graph, may have one or more associated edge attributes that define relationship information about the relationship between the nodes of the node pair represented by the edge. In a many real world examples of heterogeneous or complex node relationships, the relationship between node pairs is not explicitly captured, is incomplete, or is only partly observed for an observed graph.

A Graph Convolutional Neural Network (GCNN) can be used to process node features and relationship information to perform tasks such as node classification, link prediction and graph classification. A GCNN is a type of deep learning model. A GCNN includes aggregating functions interspersed with graph convolutional layers. A GCNN may be configured to receive a multidimensional feature vector for each node in a graph and generate a low-dimensional embedding for each node. A GCNN applies dimensionality reduction techniques to distill the high-dimensional information included in the node features included in the multidimensional feature vector for a node and neighborhood information included in the edge connection information of the node into a dense, low dimensional embedding (also known as a vector representation of a node).

The embedding for a node is generated by iteratively combining embeddings for the node itself with the embeddings for the nodes in its local neighborhood. In the context of a GCNN, embeddings are low-dimensional, learned continuous vector representations of discrete variables. Embeddings are useful because they can reduce the dimensionality of categorical variables and meaningfully represent categories in a transformed space.

During the node embedding process, a node that is the current subject of an embedding can be referred to as a central node, and the central node has a neighborhood that includes a set of adjacent nodes. In some examples, the neighborhood of a central node includes the central node and adjacent neighbor nodes, and this can be referred to as a closed neighborhood. In some examples, neighborhoods can be open, meaning the central node is not included in the neighborhood.

Generating a node embedding for a central node can be considered as having two steps: neighborhood aggregation, in which a function called an aggregator (“aggregator function”) operates over neighborhoods and aggregates the embeddings of nodes in the neighborhood into an embedding to represent the neighborhood, and central-node updating that updates the node embedding of the central node with the embedding of the neighborhood. In other words, these existing GCNNs generate embeddings for each node in an attributed graph by a function of each node and its surrounding neighborhood. However, due to the permutation invariant property of the set adjacent nodes of a central node, the neighborhood aggregation usually is a function equivariant with respect to its inputs, assuming the set of inputs (i.e., the neighborhoods) are homogeneous.

Some GCNNs with neighborhood aggregators that aggregate over open neighborhoods have at least some capability to process heterogeneous graphs that include multiple types of inter-node relationships. For example GraphSAGE [Hamilton, W.; Ying, R.; and Leskovec, J. 2017. Inductive representation learning on large graphs. In Proc. Adv. Neural Inf. Proc. Systems. arXiv:1706.02216v4 [cs.S1] 10 Sep. 2018], central nodes are excluded in neighborhood aggregation, which allows each central node can be heterogeneous to its neighborhood. However, GCNNs without aggregators able to distinguish between node types in a neighborhood are limited for application to heterogeneous graphs, since the aggregators can only consider nodes in each neighborhood as homogeneous. This contradicts the observation in real-world heterogeneous graphs (e.g., social networks, information networks and telecommunication networks) that there are edges between different types of nodes in each open neighborhood. Some known GCNNs include learnable factors for nodes in the neighborhood in their neighborhood aggregators, which allow for heterogeneous nodes in each neighborhood. These learnable factors for each node in the neighborhood are usually parameterized to functions of the node embedding of the node and its central node. With those learnable factors, GCNNs are possibly capable to process heterogeneous graphs to perform node classification.

However, the potential limitations of these GCNNs for processing heterogeneous graphs are that those learnable factors are overly flexible and that the GCNN's do not use the learnable factors consistently across different level representations (i.e., the node embeddings) for a pair of nodes. These limitations potentially lead to overfitting issues when learning heterogeneous graphs.

Existing GCNNs have some ability to incorporate both local node features and the neighborhood node features. However, there remains the need for a GCNN that applies an aggregator function that enhances learnability of graph convolutional layers on node-wise operations, thereby providing a solution that can learn meaningful node embeddings for each node from its heterogeneous neighborhood and respect the natural consistency of relationship.

### SUMMARY

According to a first aspect of the present disclosure is a computer implemented method for processing a graph structured dataset that defines a set of nodes and a set of edges associated, the nodes each having an associated set of node attributes, the edges each representing a relationship that connects two respective nodes. The method includes generating a first node embedding for each node by: generating, for the node and each of a plurality of neighbour nodes, a respective first edge attribute defining a respective relationship between the node and the neighbour node based on the node attributes of the node and the node attributes of the neighbour node; generating a first neighborhood vector that aggregates information from the generated first edge attributes and the node attributes of the neighboring nodes; generating the first node embedding based on the node attributes of the node and the generated first neighborhood vector.

In at least some applications, generating node embeddings that are based on both (i) the node attributes and (ii) a first neighborhood vector that aggregates information from the generated first edge attributes and the node attributes of the neighbour nodes can enable complex relationships between nodes to be modelled in node embeddings. This can allow the embeddings to provide more information, which can optimize the use of system resources as the consumption of one or more of computing resources, communications bandwidth and power may be reduced by generating more accurate data modelling.

In accordance with the preceding aspect, the method can further include: generating a second node embedding for each node by: generating, for the node and each of a plurality of neighbour nodes, a respective second edge attribute defining a respective relationship between the node and the neighbour node, based on the first node embedding of the node and the first node embedding of the neighbour node; generating a second neighborhood vector that aggregates information from the generated second edge attributes and the first node embeddings of the neighbour nodes; and generating the second node embedding based on the first node embedding of the node and the second generated neighborhood vector.

In accordance with one or more of the preceding aspects, each first node embedding is generated at a first layer of a graphical convolution network (GCN) and each second node embedding is generated at a second layer of the GCN.

In accordance with one or more of the preceding aspects, generating each first node edge attribute and each second node edge attribute comprises determining a vector of weighted relationship types from a defined set of a relationship types stored in a memory network.

In accordance with one or more of the preceding aspects, the memory network includes a latent relation matrix that includes a plurality of relationship types and a key matrix that includes a respective key value for each of the relationship types, wherein determining a vector of weighted relationship types comprises determining a probability value for each of the respective key values and applying the determined probability values as weights to each of the relationship types.

In accordance with one or more of the preceding aspects, the method includes for each node and neighbour node: generating the respective first edge attribute for the node and the neighbour node comprises applying a first function to combine the node attributes of the node with the node attributes of the neighbour node based on learned parameters, the vector of weighted relationship types being determined based on the output of the first function; and generating the respective second edge attribute for the node and the neighbour node comprises applying the first function to combine the first node embedding of the node with the first node embedding of the neighbour node based on the learned parameters, the vector of weighted relationship types being determined based on the output of the first function.

In accordance with one or more of the preceding aspects, generating the first node embedding for each node comprises determining the plurality of neighbour nodes for the node by sampling a fixed-size uniform draw of nodes that are within a predefined degree of relationship with the node based on the edges; and generating the second node embedding for each node comprises determining the plurality of neighbour nodes for the node by further sampling a fixed-size uniform draw of nodes that are within the predefined degree of relationship with the node based on the edges.

In accordance with one or more of the preceding aspects, for each node generating the first neighborhood vector comprises: for each of the plurality of neighbour nodes, applying a second function to combine, based on a set of learned second function parameters, the attributes of the neighbour node with the respective first edge attribute for the node and the neighbour node, and aggregating the outputs of second function to generate the first neighborhood vector; and for each node generating the second neighborhood vector comprises: for each of the plurality of neighbour nodes, applying the second function to combine, based on a further set of learned second function parameters, the neighbour node first embedding with the respective second edge attribute for the node and the neighbour node, and aggregating the outputs of second function to generate the second neighborhood vector.

In accordance with one or more of the preceding aspects, for each node, generating the first node embedding comprises: applying a third function to combine, based on a set of learned third function parameters, the attributes of the node with the first neighborhood vector; and for each node, generating the second node embedding comprises: applying the third function to combine, based on a further set of learned third function parameters, the first embedding of the node with the second neighborhood vector.

In accordance with one or more of the preceding aspects, the nodes represent transceiver devices in a wireless network and the node attributes include communication properties implemented at or measured at the respective transceiver devices, and the edges represent interactions through the wireless network between two transceiver devices.

According to a further aspect of the present disclosure is a processing device for processing a graph structured dataset that defines a set of nodes and a set of edges, the nodes each having an associated set of node attributes, the edges each representing a relationship that connects two respective nodes, the processing device comprising a non-transitory storage operatively coupled to processing unit, the non-transitory storage storing executable instructions that, when executed by the processor unit, configure the processing device to perform a method according to one or more of preceding aspects.

According to a further aspect of the present disclosure is a non-transitory computer readable medium storing executable instructions that, when executed by a processor unit, configure the processing device to perform a method according to one or more of preceding aspects.

### BRIEF DESCRIPTION OF THE DRAWINGS

Reference will now be made, by way of example, to the accompanying drawings which show example embodiments of the present application, and in which:

FIG. 1 is a block diagram illustrating an example of a machine learning embedding generator system according to example embodiments;

FIG. 2 is a flow diagram illustrating an example of an embedding process performed by the embedding generator system of FIG. 1;

FIG. 3 is a pseudocode representation of an example of an embedding process performed by the embedding generator system of FIG. 1; and

FIG. 4 is a block diagram illustrating an example processing system that may be used to execute machine readable instructions to implement the system of FIG. 2.

Similar reference numerals may have been used in different figures to denote similar components.

### DESCRIPTION OF EXAMPLE EMBODIMENTS

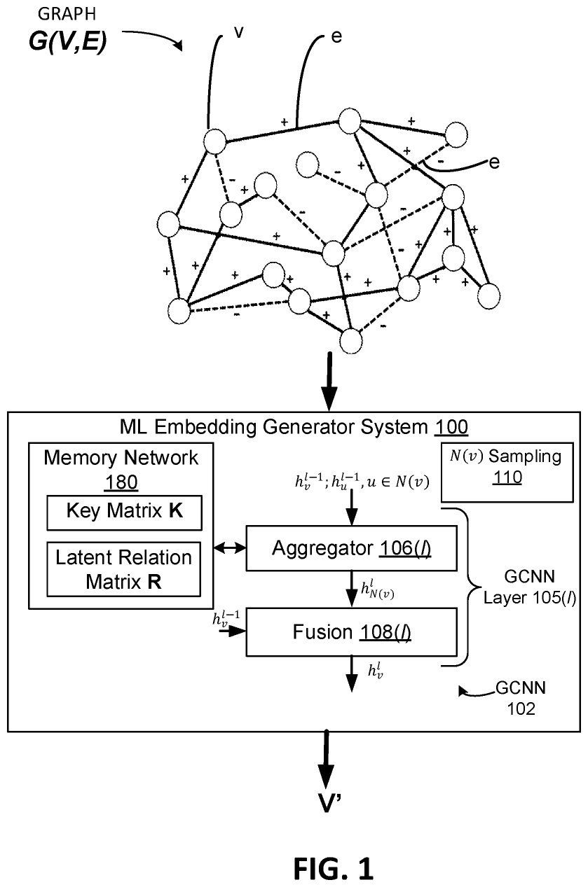

Referring to FIG. 1, according to example embodiments a machine learning (ML) embedding generator system 100 (hereinafter referred to as embedding generator system 100) is described that uses machine learned functions to collectively generate edge attribute information and node embeddings in order to process an observed graph G. Observed graph G is a data structure that represents a set of data points as nodes and relationships between the data points as edges. In some example embodiments, embedding generator system 100 can generate embeddings for nodes in the observed graph G that includes information about the nodes themselves, their neighbor nodes, and their relationships with those neighbor nodes. Embedding generator system 100 includes a memory network 180 so that the information can be accumulated over a plurality of processing iterations. The generated embeddings for the nodes of the observed graph G can then be used for downstream processing.

In the illustrated example, an observed dataset is provided that includes node information and relationship information. The observed dataset is stored as an observed graph G=(V,E), comprised of a set V of nodes v and a set E of edges e. Each node v can has a unique node ID and an associated set of node attributes (i.e., node features) for each node v. The node attributes for a given node v are represented as a respective multi-dimensional feature vector xᵥ. The relationship information includes a graph topology that defines a set of edges e. Each edge e represents a relationship that connects two nodes v. The graph G is a heterogeneous graph in that different types of relationships can exist between different node pairs v-v, as illustrated by the dashed edges e(−) and solid edges e(+). However, in example embodiments, although the observed dataset stored as a graph G includes relationship information indicating the presence or absence of edges (i.e. relationships) between node pairs v-v, it does not include explicit edge attribute information that specifies any other information about the relationship node pairs v-v.

In example embodiments, the observed graph G is a dataset (X, A) where X is a feature matrix that includes respective multi-dimensional feature vectors xᵥ for each node v included in the set V of nodes v, and A is an adjacency matrix that defines the relationships between node pairs v-v, including the presence or absence of a connecting edge e between all possible respective node pairs v-v in the set V of nodes v. Accordingly, the feature matrix X includes attribute data (i.e. feature vectors) for each node v in the form of the respective multi-dimensional feature vector xᵥ, and adjacency matrix A includes data that defines the relationships between node pairs v-v of the graph G(V,E). In some example embodiments, adjacency matrix A is an matrix of binary values, with a first binary value indicating the presence of a respective edge e linking two respective nodes vᵢ-vⱼ (e.g. a “1” at matrix location i,j indicating that there is an edge linking node vᵢ and node v) and a second binary value indicating a lack of a linking edge between two respective nodes vᵢ-vⱼ (e.g. a “0” at matrix location i,j indicating that there is no edge linking node vᵢ and node vⱼ).

As will be described in greater detail below, embedding generator system 100 is configured to determine edge attributes e_{v,u} (where v and u represent a central node and a neighbor node of the central node, respectively) as part of the process of generating node embeddings. The edge attribute e_{v,u} for an edge defines the relationship between two connected nodes v and u using a relationship value. In example embodiments, M different relationship values or classes are possible, as represented herein by the set of M possible types of latent relationship types R={r₁, r₂, . . . , r_{M}}.

Embedding Generation

In example embodiments, embedding generator system 100 includes a multi-layer GCNN 102, with each GCCN layer 105(l) including a respective aggregator function 106(l) and fusion function 108(l). In example embodiments, the multi-layer GCNN 102 includes L hidden graph convolutional layers 105(1) to 105(L), each hidden layer 105(l) having a respective set of learned parameters that define the operation of the layer's aggregator function 106(l) and fusion function 108(l). In example embodiments, learned parameters for each hidden layer 105(l) can be organized into tensors of parameter values, for example as weight matrices. A tensor is a data structure in which the location of a value within the structure has meaning, and can include a vector and a matrix, among other structures. L corresponds to a search depth, with each hidden layer 105(l) corresponding to a respective graph processing iteration. At each iteration or hidden layer 105(l), the node embeddings will aggregate information from local neighbor nodes, and the information incrementally increases to include information derived from beyond immediate neighbor nodes throughout each iteration or layer.

As indicated in FIG. 1, each hidden layer 105(l) receives as input the node embeddings h^{l-1} output from a previous hidden layer 105(l) and outputs a set of respective transformed node embeddings h^{l}. The input received at a first hidden layer 105(1) are the observed feature vectors xᵥ for the nodes v of the set V, and the output of the final hidden layer 105(L) are respective embeddings h^{L} for the nodes v in the set V of nodes v. As will be explained in greater detail below, embedding generator system 100 is memory augmented in that it includes a memory network 180 that stores information about the set of M possible latent relationship types R={r₁, r₂, . . . , r_{M}}. The “memory network 180” is a machine-learned model that cooperates with but is distinct from GCNN 102. In particular, memory network 180 stores a latent relation matrix R that includes the set of M latent relationship types R={r₁, r₂, . . . , r_{M}} together with a corresponding key kₘ for each possible relationship value rₘ. The set of M keys K={k₁, k₂, . . . , k_{M}} can be represented as a key matrix K. The stored latent relation matrix R enables edge attributes for edges e to be selected from a restricted space. In example embodiments, key matrix K and latent relation matrix R are parameters of the embedding generator system 100 that are learned in parallel during training of GCNN 102.

An overview of the operation of a function called an aggregator (hereinafter referred to as aggregator function 106(l)) and a function called fusion (hereinafter referred to as a fusion function 108(l)) will now be described, followed by a description of a practical implementation according to an example embodiment. In this regard, Equation (1) below represents the combined operations approximated by aggregator function 106(l) and fusion function 108(l) of a hidden layer 105(l) in respect of central node v selected from the set V of nodes v, where “central node v” refers to the node being processed to output a node embedding hᵥ^{l}, and “nodes u” refers to other nodes in the set V of nodes v:

hᵥ^{l}=σ(ƒ^{l}(hᵥ^{l-1},Σ_{u∈N(v)}Dᵥᵥ⁻¹·g^{l}(hᵤ^{l-1},ê_{v,u}^{l})))) Eq. (1)

Where:
A is the adjacency matrix, D is a diagonal matrix where Dᵥᵥ=ΣᵤAᵥᵤ;
hᵥ^{l-1} and hᵥ^{l} denote the node embedding of central node v at layers l−1 and l, respectively;
hᵤ^{l-1} denotes the node embedding of node u at layer l−1;
N(v) denotes the set of neighbor nodes of central node v;
σ denotes a non-linear activation function;
ƒ^{l}(⋅,⋅) and g^{l}(⋅,⋅) denote respective learned transformation functions; and

ê_{v,u}^{l} denotes an edge attribute generated at layer l for the relationship between central node v and neighbor node u.

As indicated by equation (1), each hidden layer 105(l) generates an edge attribute ê_{v,u}^{l}, for each central node-neighbor node pair v-u, that is based on the previous layer 105(l−1) node embeddings. In an example embodiment, edge attribute ê_{v,u}^{l} is a vector that can be represented by the following equation (2):

ê_{v,u}^{l}=φ(hᵥ^{l-1},hᵤ^{l-1}) Eq. (2)

Where: φ(⋅,⋅) is a learned prediction function.

In an example embodiment, the function φ(hᵥ^{l-1}, hᵤ^{l-1}) for predicting an edge attribute between node pair v-u is implemented as a Softmax function that uses parameters from memory network 180. As noted above, memory network 180 stores a latent relation matrix R and key matrix K, with each of the latent relationship types R={r₁, r₂, . . . , r_{M}} being associated with a corresponding key kₘ. In this regard, Equation (2) can take the form of equation (3):

$${\hat{e}}_{v , u}^{l} = φ ( {h}_{v}^{l - 1} , {h}_{u}^{l - 1} ) = {R}^{T} \cdot Softmax ( {K}^{T} \cdot q ( {h}_{v}^{l - 1} , {h}_{u}^{l - 1} ) ) \\ where : {Softmax ( x )}_{i} = \frac{exp ( {x}_{i} )}{{\sum }_{i = 1}^{d} exp ( {x}_{i} )} \qquad Eq . ( 3 )$$

Where d=M.

In an example embodiment, query function q(hᵥ^{l-1}, hᵤ^{l-1}) is a learned transformation function defined by equation (4):

q(hᵥ^{l-1},hᵤ^{l-1})=W₅·hᵥ^{l-1}+W₆·hᵤ^{l-1} Eq. (4)

Where: W₅ and W₆ are respective learned weight matrices (i.e., parameters), which are learned by memory network 180 in respect of each hidden layer 105(l).

Although a number of different functions can be used to implement learned functions ƒ^{l}(⋅,⋅) and g^{l}(⋅,⋅) in equation (1), in at least some example embodiments these functions take the form of learned transformation functions shown in Equations (5) and (6) below:

ƒ^{l}(c,x)=W₁^{l}·c+W₂^{l}·x Eq. (5)

g^{l}(c,x)=W₃^{l}·c+W₄^{l}·x Eq. (6)

Where: W^{l}₁, W^{l}₂, W^{l}₃ and W^{l}₄ are respective learned weight matrices for hidden layer 105(l).

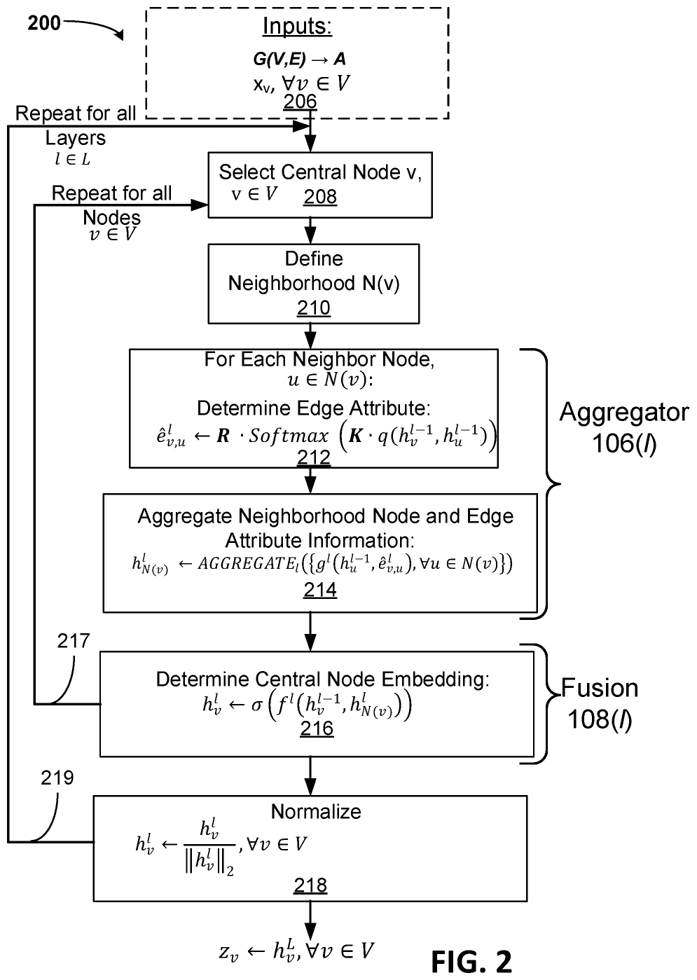

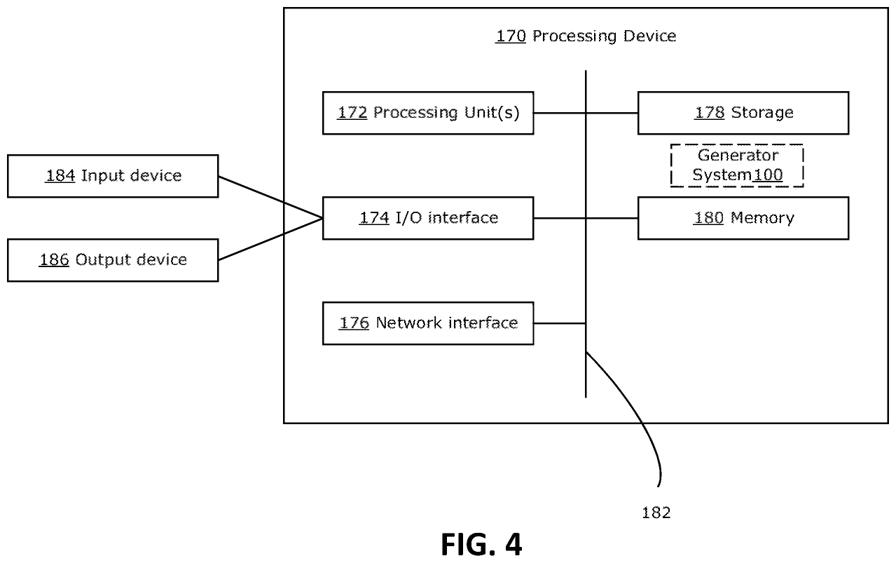

An example embodiment of how the node embedding generation (i.e., forward propagation) represented by Equation (1) is implemented by embedding generator system 100 will now be described with reference to FIGS. 1 and 2. In example embodiments, embedding generator system 100 is implemented using processing device 170 (described below with reference to FIG. 4) that is configured with software that includes computer executable instructions which when executed by the one or more processing unit(s) 172 (described below with reference to FIG. 4) of the processing device 170 cause the processing device 170 to execute the node embedding process 200 described herein.

The embedding generation process 200, as described below with reference to FIGS. 1 and 2, assumes that GCNN 102 is trained and ready to operate in inference mode (i.e. to generate predictions). In this regard, the functions used to implement the embedding generator system 100 have already been learned, and in particular, all parameters of the GCNN 102 and the external memory network 180 have been learned, including weight matrices W^{l}₁, W^{l}₂, W^{l}₃ and W^{l}₄ for layers hidden 105(1) to 105(L) of the GCNN 102, query function weight matrices W₅, W₆, and the latent relation matrix R and key matrix K. A description of how these parameters can be learned using standard stochastic decent and backpropagation techniques will be described further below.

As indicated at block 202 in FIG. 2, inputs are provided to embedding generator system 100. The observed graph G=(V,E) is provided as an input in the form of (a) adjacency matrix A that specifies the relationships between node pairs of the set V of nodes of the graph; and (b) node feature matrix X that includes input feature vectors xᵥ, ∀v∈V. A set of outer loop actions (e.g., from block 206 to block 218) are performed iteratively for a search depth of L iterations, with each iteration corresponding to a respective GCNN layer 105(l). For each of the L hidden layers 105, a set of inner loop actions (block 208 to block 216) are repeated for each node v included in set V. The blocks 212 to 214 represent actions performed by aggregator function 106(l), and block 218 represents an action performed by fusion function 108(l). The flow diagram of FIG. 2 illustrates embedding generation process 200 in the context of processing an entire observed graph G=(V,E). In some examples, the process can be modified using known minibatch processing techniques to process the graph in minibatch sets.

As indicated in block 208, a node v from the node set V is selected as a central node v. As indicated in block 210, a node neighborhood N(v) is then defined for the central node v. In some examples, the node neighborhood N(v) that is defined for central node v may include all nodes u within a defined hop radius (or degree) of central node v, for example within a 1-hop neighborhood or 1^{st} degree neighborhood (i.e., all nodes directly connected by an edge e to central node v) or within a 2-hop neighborhood (i.e., all 1-hop neighbor nodes of the central node and all nodes that are 1-hop neighbors of the 1-hop neighbor nodes of the central node). In some alternative example embodiments, the embedding generator system 100 is configured with a node neighborhood sampling function 110 that is configured to define the node neighborhood N(v) for central node v by performing random sampling of a defined number of nodes u within a defined hop radius of central node v. In such alternative embodiments, a new neighborhood N(v) may be defined for the central node v for each training iteration when training the GCNN 102. In one example embodiment where a node neighborhood N(v) is defined for an central node v by sampling, sampling function 110 defines a node neighborhood N(v) for an central node v as a fixed-size uniform draw from the set {u∈V:(u, v)∈E}, and different fixed-size uniform sample is drawn for each central node v for each training iteration. Thus, in example embodiments, at each hidden layer 105(l), the node neighborhood N(v) is then defined for central node v (i.e. the set of neighbour nodes for an central node) is determined by randomly sampling a fixed-number nodes within a uniform distribution of nodes that have a predefined degree of relationship with the central node.

As indicated at block 212, the aggregator function 106(l) is configured to generate a respective edge attribute ê_{v,u}^{l} for the central node v and each of its neighbor nodes u∈N(v). In this regard, for each central node v-neighbor node u pair, aggregator function 106(l) performs a query function q(hᵥ^{l-1}, hᵤ^{l-1})=W₅·hᵥ^{l-1}+W₆·hᵤ^{l-1} that combines a weighted version of the node embedding hᵥ^{l-1} for the central node v passed from the previous GCNN layer 105(l−1) with a weighted version of the node embedding hᵤ^{l-1} for the neighbor node u, also passed from the previous GCNN layer 105(l−1). As represented by equation (3) (ê_{v,u}^{l}←R^{T}·Softmax(K^{T}·q(hᵥ^{l-1}, hᵤ^{l-1}))), a Softmax function is applied to the representation generated by dot-multiplication of the query function and the transpose of key matrix K to generate a probability distribution for the keys included in key matrix K, which represent the relationship types. The probabilities for each of the keys k are then used as respective weights that can be applied to each of the latent relationship types r in latent relation matrix R to build a weighted edge attribute ê_{v,u}^{l}, which is a vector of M weighted relationship type values.

Thus, the edge attribute ê_{v,u}^{l} is determined based on information about features of both the central node v and the neighbor node u. As noted above, the weights applied to each feature for each of the nodes (i.e., W₅ and W₆) are learned weight matrices.

As indicated in block 214, for each central node neighbor node pair v-u, a weighed version of the edge attribute ê_{v,u}^{l} generated by the current GCNN hidden layer 105(l) for the pair is combined with a weighed version of the node embedding, hᵤ^{l-1} of the neighbor node passed from the previous GCNN hidden 105(l−1), according to the learned function g^{l}(hᵤ^{l-1}, ê_{v,u}^{l})=W₃^{l}·hᵤ^{l-1}+W₄^{l}·ê_{v,u}^{l}. Thus, g^{l}(hᵤ^{l-1}, ê_{v,u}^{l}) generates a node embedding (i.e. vector representation) that includes information about properties of the neighboring node u as well as the relationship between the central node v and neighboring node u. As noted above, the weights applied to the node embedding hᵤ^{l-1} and the weights applied to the edge attribute ê_{v,u}^{l} are learned weight matrices (i.e., W¹₃ and W^{l}₄).

For the central node v, the node embeddings (i.e. vector representations) generated by function g^{l}(hᵤ^{l-1}, ê_{v,u}^{l}) in respect of all neighbor nodes u∈N(v) are aggregated into a single neighborhood node embedding (i.e. vector representation) h_{N(v)}^{l}, as represented in equation (7):

h_{N(v)}^{l}←AGGREGATEₗ({g^{l}(hᵤ^{l-1},ê_{v,u}^{l}),∀u∈N(v)}) Eq. (7)

As indicated in block 216, learned fusion function ƒ^{l}(hᵥ^{l-1}, h_{N(v)}^{l})=W₁^{l}·hᵥ^{l-1}+W₂^{l}·h_{N(v)}^{l} is applied to combine a weighted version of the central node embedding hᵥ^{l-1} for the central node passed from the previous hidden layer 105(l−1) with a weighted version of central node neighborhood node embedding h_{N(v)}^{l}. Thus, fusion function ƒ^{l}(hᵥ^{l-1}, h_{N(v)}^{l}) generates a fused node embedding for the central node v (i.e. vector representation) that includes information about properties of the central node v as well as the central node neighborhood N(v). As noted above, the weight matrices W^{l}₁ and W^{l}₂ are populated with learned weights. Nonlinear activation function σ is then applied to the fused node embedding (i.e. vector representation) generated by fusion function ƒ^{l}(hᵥ^{l-1}, h_{N(v)}^{l}) to generate central node embedding hᵥ^{l}. As indicated by arrow 217, the actions indicated in blocks 210 to 216 are performed for all nodes v∈V. As indicated in block 218, the node embeddings hᵥ^{l} generated in respect of nodes v∈V are normalized using a normalization operation (e.g., [symbol] ) to limit the underflow or overflow of gradients during backpropagation.

The node embedding hᵥ^{l} for each node v∈V is stored in system memory network 180 so that the node embedding hᵥ^{l} for each node v∈V generated in respect of GCNN hidden layer 105(l) can be passed to subsequent hidden layer 105(l+1).

As indicated by arrow 219, the actions described above are performed in respect of all GCNN hidden layers 105(1), . . . , 105(L). The final vector that includes the node embeddings for all the nodes output by the final GCNN hidden layer 105(L) are denoted as zᵥ=hᵥ^{L}, ∀v∈V.

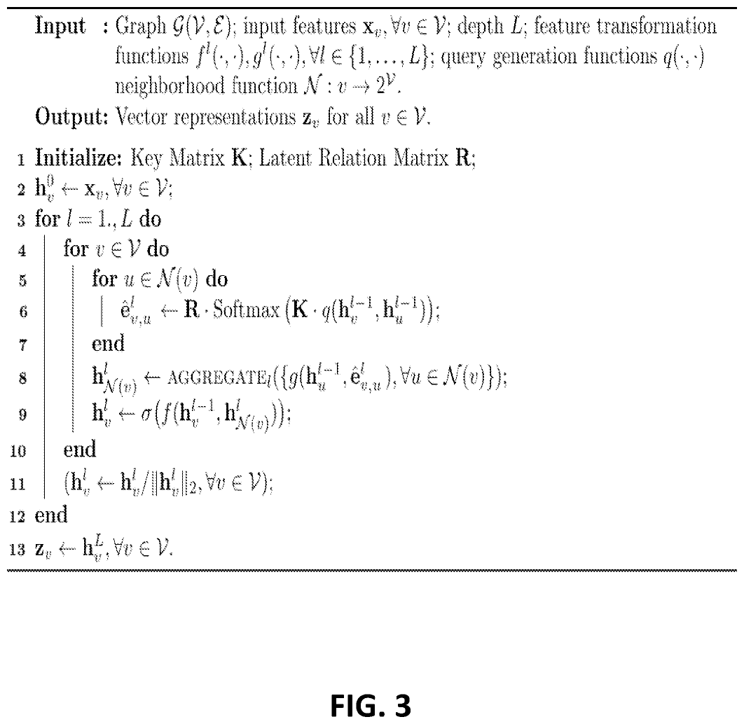

FIG. 3 is a pseudocode representation of the example embedding process 200 shown in FIG. 2 and performed by the embedding generator system 100 of FIG. 1.

In example embodiments, the final vector embeddings zᵥ for the nodes from the final GCNN hidden layer 105(L) of the GCNN 102 are used as inputs to one or more further ML based systems. For example, final embeddings zᵥ for the nodes can be used as inputs for one or more artificial neural network based decoders (i.e. decoders that are implemented as an artificial neural network) that are configured to perform node labelling, node clustering, link prediction and/or other functions.

Training

In an example embodiment, in order to learn the parameters of non-linear functions represented in equations 5, 6, 4 (e.g., W^{l}₁, W^{l}₂, W^{l}₃, W^{l}₄, W₆, W₅), and the learn key matrix K and latent relation matrix R, using supervised or semi-supervised learning algorithm, a graph-based loss function is used to compute a loss of the output representations, zᵤ, ∀u∈V, and backpropagation is used to tune (i.e. update) the weights in the weight matrices, W^{l}, ∀l∈{1, . . . , L}, and the parameters in W₆, W₅ of the query function via stochastic gradient descent. The graph-based loss function encourages nodes that are close to each other (e.g., nearby nodes) to have similar representations, while enforcing that the representations of disparate nodes are highly distinct (Equation (8)):

[symbol]

(zᵤ)=−log(σ(zᵤ^{T}zᵥ))−Q· [symbol] ᵥ_{ₙ}_{˜P}_{ₙ}₍ᵥ₎ log(σ(−zᵤ^{T}zᵥ_{ₙ})) EQ. (8)

where v is a node that co-occurs near u on fixed-length random walk, σ is the sigmoid function, Pₙ is a negative sampling distribution, and Q defines the number of negative samples. The representations zᵤ that are fed into loss function are generated from the features contained within a node's local neighborhood, rather than training a unique embedding for each node. The loss function considers nearby nodes of a central node v to be the set of nodes passed by a random walker/surfer starting from the central node v. A random walker/surfer, as indicated by its name, is a walker/surfer that randomly go to an adjacent node of the node the walker/surfer currently is at. As known in the art, the set of nodes passed by a random walker starting from node v, will be close to node v from the sense of graph topology.

Subject to the differences in the actual weights, the training of GCNN 102 applies techniques known for GCNN training such as those described in Kipf, T., and Welling, M. 2017. Semi-supervised classification with graph convolutional networks. In Proc. Int. Conf. Learning Representations https://arxiv.org/pdf/1609.02907.pdf. In an example embodiment, in order to learn the parameters of feature distillation functions represented in equations 5, 6, 4 (e.g., Wl1, Wl2, Wl3, Wl4, W6, W5), and the learned key matrix K and latent relation matrix R, parameters W6, W5 of the query function, using a supervised/semi-supervised learning algorithm and a training dataset, a cross-entropy based loss function is applied to the output representations, Zu, ∀u∈V′, via an gradient descent based optimizer, EQ. (8):

$$ℒ = - {\sum }_{u ∈ {V}^{′}} {\sum }_{f = 1}^{F} {y}_{uf} {Z}_{uf} \qquad ( Equation ( 8 ) )$$

where V′ is a set of nodes in training set, σ is the sigmoid function; [symbol] is the one-hot label for node u, and f is corresponding the fth entry in the vector, where the vector can be either yᵤ or zᵤ. The representations Zu that are fed into loss function are generated from the features contained within a node's local neighborhood, rather than learning a unique node embedding for each node.

During training, the loss function is applied to compute a loss that is based on the differences between true labels as known from a training dataset and the predicted labels from a model that incorporates the embedding generator system 100. Backpropagation computes the gradients of each of the parameters of the embedding generator system with respect to the loss (i.e., the gaps between the true and predicted) via the chain-rule of gradients. A gradient descent optimization method is applied to update the parameters with the computed gradients w.r.t loss from backpropagation.

One non-limiting example of a possible application for embedding generator system 100 is in the context of communications networks. Graph structured data can be used to manage wireless cellular networks, Wi-Fi networks, and fixed networks. In communications networks, transceiver devices (e.g., base stations, access points, user devices, user stations, routers, caches, and other network nodes) may be represented as nodes. The adjacent nodes, for example nodes that represent network devices that are connected in a physical layer or have physically adjacent locations, might have high correlation in terms of each node device's performance. The node attributes include communication properties implemented at or measured at the respective transceiver devices. The communication properties could include the transmission power, the user traffic, the transition bandwidth and, etc. Each node in a telecommunication graph can be represented as a respective multi-dimensional feature vector xᵥ. In many cases, the edges represented in an observed graph dataset available for a communications network are unattributed (e.g., unlabeled) with the result that all messaging between nodes are assumed to follow the same pattern. However, in realty the relationships between the nodes can be complex. For example, for the transmission power feature, the adjacent cell will have a negative correlation. But on the traffic user feature, the adjacent cell might have a positive correlation. Concretely, there might be an implicit M latent relationship types R={r₁, r₂, . . . , r_{M}} that can be learned to represent the complex interaction in the wireless networks. In at least some examples, embedding generator system 100 can be applied to a graph dataset representing a communication network and used to generate node embeddings that include learnable relationship information that accounts for the heterogeneous nature of the communication network. Accordingly, in some applications, embedding generator system 100 may enable capture of information about the complex interaction between cells (wireless networks), access points (Wi-Fi Networks) and network elements (Fixed Networks). The resulting low dimension node embeddings can then be used for many different applications, such as telecommunication network parameter configuration, anomaly detection and performance metric prediction (traffic and delay). At least some of these applications may include respective downstream machine learning classification systems that have been trained using respective reward algorithms. A potential application in a wireless network is as follows. In a wireless network, it is important to achieve automatic tuning of system parameters such as, but not limited to, transmission power (e.g., the transmission power used for the frequency bandwidth that a base station operates within), transmission bandwidth, and cell individual offset (CIO) (which is the parameter to control the handover behavior between the adjacent cells). To achieve a good parameter exploration model, this problem can be structured as a reinforcement learning problem where the hyperparameters that are to be automatically tuned will serve as actions. The overall objective of the problem is to take actions (different hyperparameter values) in an environment in order to maximize some notion of cumulative reward. In the wireless network, the reward of interest is the border user ratio (e.g., the number of users of a base station channel who are experiencing substandard communication quality divided by the total user number operating on the base station channel. Thus, it is important to build a reward model given the current state (cell features) and actions. The reward model will accurately predict the reward value which is the border user ratio for each cell. Wireless networks can be represented as a graph that can be processed using a GNN to serve as the reward model to mimic how the environment will respond given the current states (network status and their relationships between cells in the wireless network) and action (the parameter we choose to control the communication system). In this setting, every cell in the wireless network is a node of the graph. The graph is constructed based on the handover number between the adjacent cells. The node attributes contain the cell status (current number of user equipments (UEs) in the cell, downlink traffic, uplink traffic, maximum users and etc.) and the cell parameters (transmission power, CIO), which can be represented as a respective multi-dimensional feature vector xᵥ. The objective is to predict the border user ratio given the node features and underlying topology. The above disclosed memory network supported GCNN model can be beneficially applied in a wireless communications network where the interaction between adjacent cells can be quite complex and unknown in advance. The implicit interaction type (e.g., relationship types) could be 1) interference 2) occurrence 3) similarity, and others. Concretely, there might be an implicit M latent relationship types R={r₁, r₂, . . . , r_{M}} that can be learned to represent the complex interaction in the wireless networks. Our disclosed memory network supported GCNN model are able to jointly learn the implicit edge type embeddings for each relations as well as the downstream task (predict the boarder user ratio given the input node features and graph). The additional memory networks for edge type encoding process disclosed in our invention enables to capture the complex interaction for the adjacent nodes in the wireless networks. The existing GCNN model treats all the interaction between adjacent cells as the same, which is the main reason they cannot perform well under in complex settings.

Processing Device

In example embodiments, embedding generator system 100 is computer implemented using one or more computing devices. FIG. 4 is a block diagram of an example processing device 170, which may be used in a computer device to execute machine executable instructions to implement embedding generator system 100. Other processing units suitable for implementing embodiments described in the present disclosure may be used, which may include components different from those discussed below. Although FIG. 4 shows a single instance of each component, there may be multiple instances of each component in the processing device 170.

The processing device 170 may include one or more processing unit(s) 172, such as a processor, general processor unit, accelerator unit, artificial intelligence processing unit, a microprocessor, an application-specific integrated circuit (ASIC), a field-programmable gate array (FPGA), a dedicated logic circuitry, or combinations thereof. The processing device 170 may also include one or more input/output (I/O) interfaces 174, which may enable interfacing with one or more appropriate input devices 184 and/or output devices 186. The processing device 170 may include one or more network interfaces 176 for wired or wireless communication with a network.

The processing device 170 may also include one or more storage units 178, which may include a mass storage unit such as a solid state drive, a hard disk drive, a magnetic disk drive and/or an optical disk drive. The processing device 170 may include one or more memories 180, which may include a volatile or non-volatile memory (e.g., a flash memory, a random access memory (RAM), and/or a read-only memory (ROM)). The memory(ies) 180 may store instructions for execution by the processing device(s) 172, such as to carry out examples described in the present disclosure. The memory(ies) 180 may include other software instructions, such as for implementing an operating system and other applications/functions.

There may be a bus 182 providing communication among components of the processing device 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure are incorporated herein by reference.

1. A computer implemented method for processing a graph that includes a set of nodes and a set of edges, the nodes each having an associated set of node attributes, the edges each representing a relationship that connects two respective nodes in the set of nodes, the method comprising:
generating a first node embedding for each node by:
generating, for the node and each of a plurality of neighbour nodes, a respective first edge attribute defining a respective relationship between the node and the neighbour node based on the node attributes of the node and the node attributes of the neighbour node;
generating a first neighborhood vector representation that aggregates information from the generated first edge attributes and the node attributes of the neighbour nodes;
generating a first node embedding based on the node attributes of the node and the generated first neighborhood vector representation.

2. The method of claim 1 further comprising:
generating a second node embedding for each node by:
generating, for the node and each of a plurality of neighbour nodes, a respective second edge attribute defining a respective relationship between the node and the neighbour node, based on the first node embedding of the node and the first node embedding of the neighbour node;
generating a second neighborhood vector representation that aggregates information from the generated second edge attributes and the first node embeddings of the neighbour nodes; and
generating the second node embedding based on the first node embedding of the node and the second generated neighborhood vector representation.

3. The method of claim 2 wherein each first node embedding is generated at a first layer of a graphical convolutional network (GCNN) and each second node embedding is generated at a second layer of the GNCN.

4. The method of claim 3 wherein generating each first node edge attribute and each second node edge attribute comprises determining a vector of weighted relationship types from a defined set of a relationship types stored in a memory network.

5. The method of claim 4 wherein the memory network includes a latent relation matrix that includes a plurality of relationship types and a key matrix that includes a respective key value for each of the relationship types, wherein determining a vector of weighted relationship types comprises determining a probability value for each of the respective key values and applying the determined probability values as weights to each of the relationship types.

6. The method of claim 4 wherein,
for each node and neighbour node:
generating the respective first edge attribute for the node and the neighbour node comprises applying a first function to combine the node attributes of the node with the node attributes of the neighbour node based on learned parameters, the vector of weighted relationship types being determined based on the output of the first function; and
generating the respective second edge attribute for the node and the neighbour node comprises applying the first function to combine the first node embedding of the node with the first node embedding of the neighbour node based on the learned parameters, the vector of weighted relationship types being determined based on the output of the first function.

7. The method of claim 2 wherein:
generating the first node embedding for each node comprises determining the plurality of neighbour nodes for the node by sampling a fixed-size uniform draw of nodes that are within a predefined degree of relationship with the node based on the edges; and
generating the second node embedding for each node comprises determining the plurality of neighbour nodes for the node by further sampling a fixed-size uniform draw of nodes that are within the predefined degree of relationship with the node based on the edges.

8. The method of claim 2 wherein,
for each node generating the first neighborhood vector comprises:
for each of the plurality of neighbour nodes, applying a second function to combine, based on a set of learned second function parameters, the attributes of the neighbour node with the respective first edge attribute for the node and the neighbour node, and
aggregating the outputs of second function to generate the first neighborhood vector; and
for each node generating the second neighborhood vector comprises:
for each of the plurality of neighbour nodes, applying the second function to combine, based on a further set of learned second function parameters, the neighbour node first embedding with the respective second edge attribute for the node and the neighbour node, and
aggregating the outputs of second function to generate the second neighborhood vector.

9. The method of claim 2 wherein,
for each node, generating the first node embedding comprises: applying a third function to combine, based on a set of learned third function parameters, the attributes of the node with the first neighborhood vector; and
for each node, generating the second node embedding comprises: applying the third function to combine, based on a further set of learned third function parameters, the first embedding of the node with the second neighborhood vector.

10. The method of claim 2 wherein the nodes represent transceiver devices in a wireless network and the node attributes include communication properties implemented at or measured at the respective transceiver devices, and the edges represent interactions through the wireless network between two transceiver devices.

11. A processing device for processing a graph structured dataset that defines a set of nodes and a set of edges, the nodes each having an associated set of node attributes, the edges each representing a relationship that connects two respective nodes, the processing device comprising:
a non-transitory storage operatively coupled to processing unit, the non-transitory storage storing executable instructions that, when executed by the processor unit, configure the processing device to perform a method comprising:
generating a first node embedding for each node by:
generating, for the node and each of a plurality of neighbour nodes, a respective first edge attribute defining a respective relationship between the node and the neighbour node based on the node attributes of the node and the node attributes of the neighbour node;
generating a first neighborhood vector that aggregates information from the generated first edge attributes and the node attributes of the neighbour nodes;
generating the first node embedding based on the node attributes of the node and the generated first neighborhood vector.

12. The system of claim 11 wherein the method further comprises:
generating a second node embedding for each node by:
generating, for the node and each of a plurality of neighbour nodes, a respective second edge attribute defining a respective relationship between the node and the neighbour node, based on the first node embedding of the node and the first node embedding of the neighbour node;
generating a second neighborhood vector that aggregates information from the generated second edge attributes and the first node embeddings of the neighbour nodes; and
generating the second node embedding based on the first node embedding of the node and the second generated neighborhood vector.

13. The system of claim 12 wherein each first node embedding is generated at a first layer of a graphical convolution network (GCN) and each second node embedding is generated at a second layer of the GCN.

14. The system of claim 13 wherein the method further comprises wherein generating each first node edge attribute and each second node edge attribute comprises determining a vector of weighted relationship types from a defined set of a relationship types stored in a memory network.

15. The system of claim 14 wherein the memory network includes a latent relation matrix that includes a plurality of relationship types and a key matrix that includes a respective key value for each of the relationship types, wherein determining a vector of weighted relationship types comprises determining a probability value for each of the respective key values and applying the determined probability values as weights to each of the relationship types.

16. The system of claim 14 wherein the method further comprises:
for each node and neighbour node:
generating the respective first edge attribute for the node and the neighbour node comprises applying a first function to combine the node attributes of the node with the node attributes of the neighbour node based on learned parameters, the vector of weighted relationship types being determined based on the output of the first function; and
generating the respective second edge attribute for the node and the neighbour node comprises applying the first function to combine the first node embedding of the node with the first node embedding of the neighbour node based on the learned parameters, the vector of weighted relationship types being determined based on the output of the first function.

17. The system of claim 12 wherein the method further comprises:
generating the first node embedding for each node comprises determining the plurality of neighbour nodes for the node by sampling a fixed-size uniform draw of nodes that are within a predefined degree of relationship with the node based on the edges; and
generating the second node embedding for each node comprises determining the plurality of neighbour nodes for the node by further sampling a fixed-size uniform draw of nodes that are within the predefined degree of relationship with the node based on the edges.

18. The system of claim 12 wherein the method further comprises:
for each node generating the first neighborhood vector comprises:
for each of the plurality of neighbour nodes, applying a second function to combine, based on a set of learned second function parameters, the attributes of the neighbour node with the respective first edge attribute for the node and the neighbour node, and
aggregating the outputs of second function to generate the first neighborhood vector; and
for each node generating the second neighborhood vector comprises:
for each of the plurality of neighbour nodes, applying the second function to combine, based on a further set of learned second function parameters, the neighbour node first embedding with the respective second edge attribute for the node and the neighbour node, and
aggregating the outputs of second function to generate the second neighborhood vector.

19. The system of claim 12 wherein the method further comprises:
for each node, generating the first node embedding comprises: applying a third function to combine, based on a set of learned third function parameters, the attributes of the node with the first neighborhood vector; and
for each node, generating the second node embedding comprises: applying the third function to combine, based on a further set of learned third function parameters, the first embedding of the node with the second neighborhood vector.

20. The system of claim 11 wherein the nodes represent transceiver devices in wireless network and the node attributes include communication properties implemented at or measured at the respective transceiver devices, and the edges represent interactions through the wireless network between two transceiver devices.
